(19) United States
(12) Patent Application Publication
(10) Pub. No.: US 2008/0292888 A1
(43) Pub. Date: Nov. 27, 2008

(54) Microfabrication

(75) Inventors: Martyn John Hucker, North Somerset (GB); Clyde Warsop, Gloucestershire (GB)

Correspondence Address: BUCHANAN, INGERSOLL & ROONEY PC, POST OFFICE BOX 1404, ALEXANDRIA, VA, 22313-1404, US

(73) Assignee: BAE SYSTEMS plc, London (GB)

(21) Appl. No.: 11/597,281

(22) PCT Filed: Oct. 20, 2006
(86) PCT No.: PCT/GB2006/003898

§ 371 Date: Jun. 5, 2007

(30) Foreign Application Priority Data
Oct. 20, 2005 (EP) 05256513.2
Oct. 20, 2005 (GB) 0521359.0

(51) Int. Cl. B32B 17/06

(52) U.S. Cl. 428/428; 156/285

(57) ABSTRACT

A method of forming a surface of micrometer dimensions conforming to a desired contour for a MEMS device, the method comprising providing a crystalline silicon substrate with a recess in an upper surface, providing a thinner layer of crystalline silicon over the upper surface of the substrate, fusion bonding the layer to the substrate under vacuum conditions, and applying heat to the layer and applying atmospheric pressure on the layer, such as to plastically deform the diaphragm within the recess to the desired contour. The substrate may form the fixed electrode of an electrostatic MEMS actuator, operating on the zip principle.

The present invention relates to a process for fabricating devices on a micrometer scale, and to devices so fabricated, particularly though not exclusively MEMS devices that may be used as electrostatic actuators.

### BACKGROUND ART

MEMS devices having parts such as cantilever beams that move under the influence of electrostatic force are well known. Electrostatic MEMS actuators working on the so called “zip” principle are known and have the advantage of producing far greater displacement of the moving parts: see J.-R. Frutos, Y. Bailly, C. Edouard, F. Bastien & M. de Labachelerie, Microactionneurs électrostatiques pour le contrôle aérodynamique, 39ème colloque d'Aérodynamique Appliquée, Mar. 22-24 2004, Paris, France J.-R Frutos, Y. Bailly, D. Vernier, J.-F Manceau, F. Bastien, M. de Labachelerie, “An electrostatically actuated valve for turbulent boundary layer control”, session A1L-E, 4th IEEE Intl. Conf. on Sensors, Irvine, Calif., Oct. 31-Nov. 1, 2005.

Zip devices usually have a fixed electrode and a moving electrode. As the moving electrode moves toward the fixed electrode, it gradually comes into contact from one end with the fixed electrode, so that the electrodes move together in a manner similar to a zip fastener. The ‘zip’ operating principle is as follows. The electrostatic pressure (pₑₗ) between two parallel electrodes can be given by the following equation, where (V) is the voltage, (d) is the gap between the electrodes and (ε₀) is the permittivity of a vacuum.

$${p}_{el} = \frac{{ɛ}_{0}}{2 {d}^{2}} {V}^{2}$$

As electrostatic force is proportional to the Inverse square of the distance between the electrodes, the maximum available force is produced when the gap between electrodes is at its smallest. It is possible to produce a large deflection by arranging the electrodes such that a small gap is always maintained at the point of closure between the moving and static electrodes. As the moving electrode deflects, the point of closure between it and the fixed electrode moves with it and the electrodes ‘zip’ together. By arranging the electrodes in this fashion it is possible to achieve much larger deflections than could otherwise be obtained with parallel electrodes.

The zipping effect may be achieved by use of a compliant moving electrode and a fixed electrode with a predefined shape or contour. For maximum effectiveness the surface of the fixed electrode desirably has a gentle continuous contour with no steps and desirably has the smoothest possible surface finish.

MEMS devices in general commonly have substrates of crystalline silicon, which is problematic for formation of gentle contours of arbitrary shape. Conventional micro-fabrication techniques are generally planar and methods for forming out of plane features in silicon are unusual. Two deep reactive ion etching (DRIE) techniques (grey scale masking and aspect ratio induced differential etching also known as ‘DRIE lag’) have been proposed but the surfaces produced by these methods are either too rough for zip actuator applications or control of the etched profile at larger depths is problematic. In grey scale masking, a lithographic mask is divided into pixels, having sub-resolution areas for transmitting light which are variable in size. The photoresist material after exposure to light through the mask has a variable depth depending on the sub-resolution areas. Etching the photoresist by a DRIE process will produce a desired slope in the substrate surface. Details of the DRIE process are disclosed in “Microfabrication of 3D silicon MEMS structures using gray-scale lithography and deep reactive ion etching”, C. M. Waits et al, Sensors and Actuators A 119 (2005) 245-253. Whilst it is possible to achieve gradual contours with this technique, nevertheless even more gradual and smoother contours are desirable.

U.S. Pat. No. 6,724,245 and U.S. Pat. No. 6,514,389 disclose a semiconductor wafer having at a certain stage in its fabrication at least one recess in its surface. In order to fill the recess, and to provide a flat surface of the wafer for subsequent processing, the recess is filled by depositing a sandwich of metallic layers over the workpiece surface, and then applying heat and pressure to deform the sandwich to fill the recess.

US-A-2003/0231967 discloses a micropump assembly wherein curved pump electrodes are formed by buckling a sandwich of oxide/polysilicon/nitride layers. Such layers are formed on a substrate surface, and holes are DRIE etched through the sandwich and into the substrate. Subsequently, a wet silicon etch through the holes creates a recess under the sandwich, and stresses inherent in the sandwich cause elastic deformation and buckling of the sandwich to a curved configuration. Since the deformation is elastic, the deformation may be lost or changed under certain conditions, e.g. temperature changes, or a subsequent processing requirement to remove a layer of the sandwich.

In a different and unrelated context, Huff, M. A. Nikolich, A. D. Schmidt, M. A. in: Solid-State Sensors and Actuators, 1991. Digest of Technical Papers, TRANSDUCERS '91., 1991 International Conference: 24-27 Jun. 1991 pages: 177-180 report a threshold pressure switch with mechanical hysteresis. The expansion of trapped gas in a sealed cavity formed by wafer bonding is used to plastically deform a thin silicon membrane bonded over the cavity, creating a spherically shaped cap.

### SUMMARY OF THE INVENTION

The concept of the invention is based on creating a desired contour for a MEMS device by providing a layer or diaphragm of silicon that is placed over a recess in a substrate, which layer is then plastically deformed against the surface of the recess by application of heat and force. The resulting surface of the silicon layer is generally very smooth and conforms to the desired contour. Whilst as noted above, plastic deformation of silicon has been previously reported in other unrelated contexts, plastic deformation of silicon in accordance with the invention has not previously been proposed.

The present invention provides in a first aspect, a method of forming a surface of micrometer dimensions conforming to a desired contour, the method comprising providing a substrate with a recess in a surface thereof, providing a layer of a predetermined material over the surface of the substrate to cover the recess, bonding at least edge regions of said layer to the substrate, and applying heat to said layer and applying pressure on said layer, such as to plastically deform said layer within the recess to a desired contour.

As preferred the layer is bonded to the substrate in regions surrounding the recess, and the space between the recess and layer is evacuated to create a vacuum pressure. Application of heat will then enable plastic deformation and a drawing in of the layer to the rough contour of the recess. The deformation of the layer is controlled by the recess, in that the surface of the recess acts as a stop for further deformation, once the layer engages the surface.

Due to the cavity being evacuated the pressure differential across the layer can be fully independently controlled, i.e it is not dependent on the temperature. Any combination of pressure and temperature may be used to suit the materials employed. Venting apertures may subsequently be formed in the plastically deformed layer to stabilize the deformation.

The method in accordance with the invention may in general produce smoother and more accurate contours than the gray scale etching process referred to above. Alternatively, the process of the invention may produce a contour to a required degree of smoothness and accuracy, more simply and inexpensively than a gray scale process. The process of the invention is in general much smoother as the distortion mechanism involves the movement of dislocations in the crystal lattice. Dislocation steps can be as small as a few interatomic distances, a few hundred picometers i.e. 2-3 orders of magnitude smaller than the grey-scale process referenced above. The case with amorphous materials such as glasses would be even smoother as there would be no crystalline steps arising from dislocations; it may be possible in accordance with the invention to produce a continuous surface that is smooth down to atomic scales. In contrast slopes produced by aspect ratio induced DRIE lag usually have large (relatively speaking) steps of several microns.

As preferred the substrate is recessed with a recess shape conforming to the desired platform and of the desired depth. In an alternative embodiment the recess is grey-scale etched. Better profile control is possible by shaping the floor of the cavity e.g. in steps by grey scale etching.

The material of the substrate may be crystalline silicon or a glass such as pyrex glass. In some applications, other materials may be employed, for example metals, ceramics and thermoplastic polymers or any other materials that exhibit a transition from elastic to plastic behaviour under predetermined conditions.

As regards the dimensions of said layer, its width or diameter may be of the order of millimetres, say between 1 mm and 50 mm. The depth of the deformed layer within the recess may be of the order of 100 micrometers, between 50 and 1000 micrometers.

In a second aspect, the invention provides a MEMS device including a substrate having a recess in a surface thereof, and a single layer of predetermined material bonded to the substrate and plastically deformed within the recess so as to constitute the surface of the recess, the surface of the recess conforming to a desired contour.

The MEMS device of the invention may be used in various applications. In one preferred embodiment, it may be used to provide a fixed electrode with a smooth and gently contoured surface, in a zip electrostatic actuator of the type above described. Alternatively, the device may be used in other applications, for example to define a lens for use in optical applications.

### BRIEF DESCRIPTION OF THE DRAWINGS

A preferred embodiment of the invention will now be described with reference to the accompany drawings wherein:—

FIGS. 1A to 1D are schematic views indicating the process steps of the preferred embodiment of the invention;

FIGS. 2 and 3 are views of a silicon wafer including a plurality of devices produced by the preferred embodiment of the invention;

FIG. 4 is a cross-sectional view of a device according to the preferred embodiment of the invention; and

FIG. 5 is a schematic view of a MEMS device according to an embodiment of the invention forming a zip actuator.

### DESCRIPTION OF THE PREFERRED EMBODIMENT

A preferred embodiment of the invention comprises a dish shaped fixed electrode fabricated in silicon. A vacuum cavity is formed by etching a recess to the required depth in a thicker base wafer. A thinner capping layer or diaphragm is bonded onto the base wafer under vacuum. The wafer is then heated at atmospheric pressure to a temperature beyond that where plastic flow occurs in the silicon and the pressure differential produced across the silicon membrane provides the necessary load to drive the distortion process. As atmospheric pressure is used to drive the plastic deformation process this results in the load being applied evenly over the entire surface of the capping membrane and so results in a smooth curve.

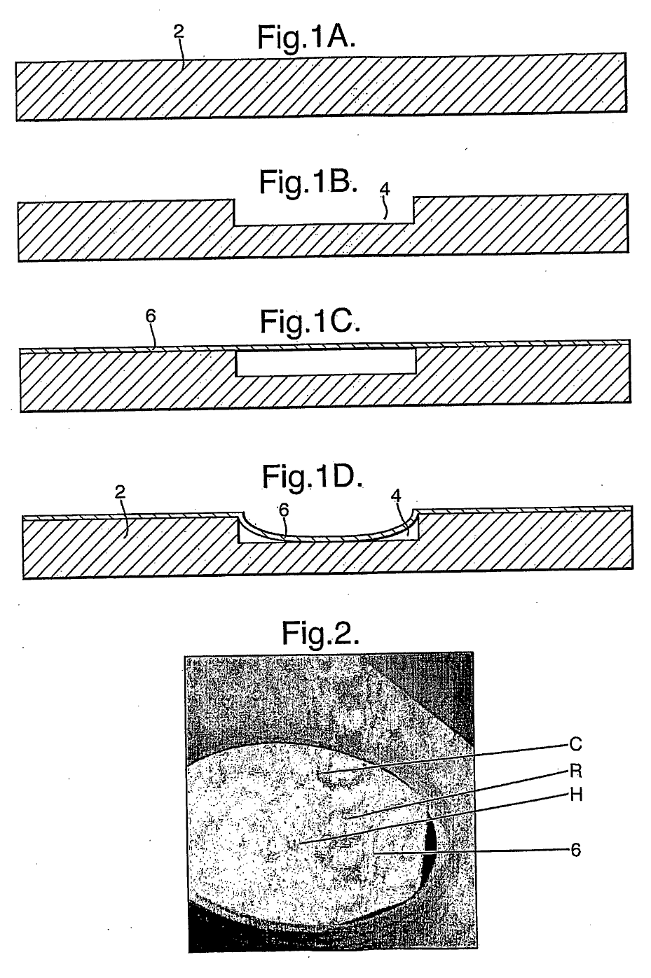

Referring to FIGS. 1 to 3, a pattern was created in a crystalline silicon wafer which produced set of 6 mmxl0 mm rectangular R and 12 mm diameter circular cavities C. Each cavity was formed by the process illustrated in FIG. 1.

Thus FIG. 1A shows part of a silicon wafer forming a substrate 2.

In FIG. 1B, a cavity or recess 4 is etched to required depth in the substrate 2 using DRIE—Deep Reactive Ion Etching.

In FIG. 1C, a thin capping wafer or layer 6 overlies recess 4 and is bonded to the substrate wafer 2 under vacuum.

In FIG. 1D, the bonded wafers are annealed at high temperature at atmospheric pressure. This creates plastic deformation of the capping layer within the cavity. Plastic deformation of the silicon capping wafer is limited by depth of the cavity; when the capping wafer contacts the base of the recess, further deformation is prevented.

Each cavity 4 is etched to a depth of 100 μm in the 525 μm thick substrate wafer 2. After cleaning 150 μm thick capping wafer 6 is attached to the base wafer under vacuum by direct fusion bonding, involving heat and mechanical pressure. The conditions are for example a vacuum <10⁻⁴ mbar, temperature 500° C. for 3 hours and 1000 Newtons mechanical pressure

The bonded wafers are annealed at 1000° C. in nitrogen at atmospheric pressure for 4 hrs. The high temperature anneal completed the fusion bonding process and caused plastic deformation of the capping wafer in a predetermined way.

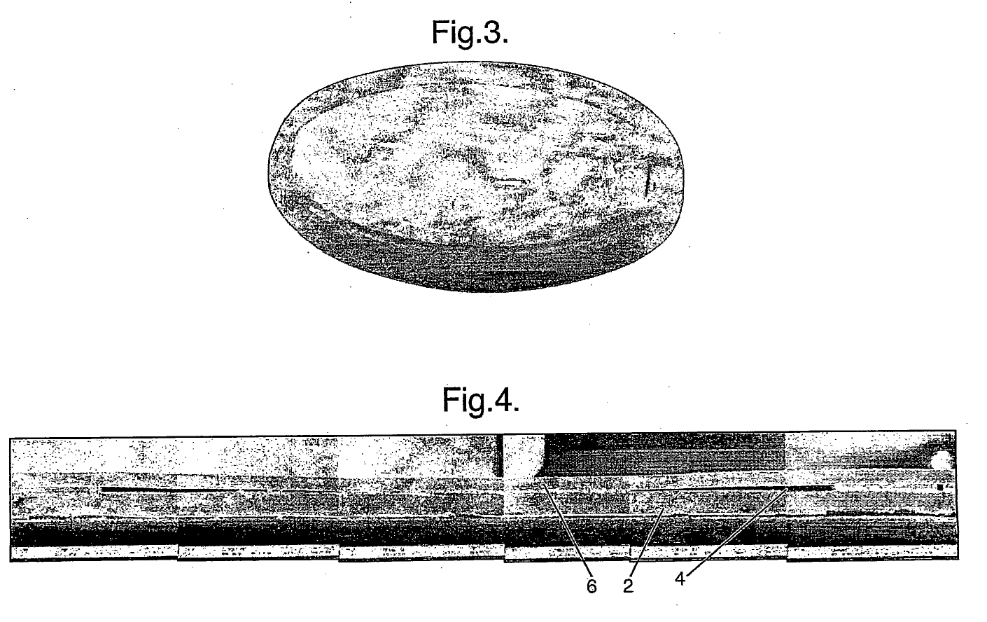

FIGS. 2 and 3 show the surface of the capping wafer and illustrate the distortion obtained. Measurements of the distorted surface showed a smooth symmetrical curve from the edge to the centre with no obvious steps or kinks. The distortion stopped when the capping wafer touched down on the base of the vacuum cavity and so the method gives good control over final curvature. Holes H were etched in the capping wafer to relieve the pressure differential so that the degree of plastic deformation could be established. Measurements of maximum cavity depth taken before and after the cavities were vented showed virtually no difference (<1 μm) which indicated that the major part of the distortion was due to plastic flow of the silicon and hence was permanent. One of the 12 mm diameter circular cavities C was sectioned and is shown in FIG. 4 and the section showed little sign of elastic return. For an electrostatic actuator application where the substrate forms a fixed electrode, this facility to allow the cavity formed under the fixed electrode to be vented so that its shape and deflection would not be affected by subsequent changes in ambient pressure during use of the actuator.

As the load is applied by a pressure differential it is possible to achieve a similar effect by sealing the cavity at some known pressure and changing the external pressure during the anneal stage. This may allow finer control over the final cavity depth. Generally, the structural stiffness of the capping wafer needs to be less than that of the cavity wafer so that distortion only occurs in the capping wafer but as structural stiffness scales with the cube of thickness, e.g. doubling the thickness increases resistance to bending by a factor of 8, this is not too difficult to arrange. Single crystal silicon is highly anisotropic and its yield stress varies both with temperature and crystallographic orientation so choice of wafer type may have some bearing on the exact processing conditions. More precise information on silicon is given in Fruhauf et al, J. Micromech. Microeng. 9 (1999) 305-312 “Silicon as a plastic material”.

A well defined yield stress means that the process is self limiting. The process conditions are tailored such that the stress in the unsupported silicon membrane is above the yield point so that yielding continues until the centre of the capping membrane touches down at the base of the vacuum cavity. At this point the extra support causes the stress in the membrane to drop below the yield point and so no further plastic distortion can occur.

An alternative embodiment includes the use of anodically bonded Pyrex glass as the capping layer. A test was conducted using a 300 μm thick Pyrex wafer and a 425 μm thick silicon wafer. As before 100 μm cavities were etched in the silicon wafer. The Pyrex was anodically bonded under vacuum at 400° C. Once the bond was complete the temperature was raised to 550° C. and the bond chamber was purged with nitrogen at atmospheric pressure. These conditions were held for 30 minutes after which the wafer was cooled to room temperature. Examination of the wafer showed plastic deformation of the glass as above. This process may give more flexibility in design as the temperatures required for plastic flow in Pyrex (500-550° C.) are considerably lower than those required for flow in silicon (>700° C.) and so the distortion can be limited to the capping layer exclusively. This factor would allow much thinner wafers to be used for both capping and cavity layers. This variation has the advantage that the bonding and deformation stages can be undertaken as a single process in-situ within the bonder apparatus in addition to extending the range of materials that can be processed.

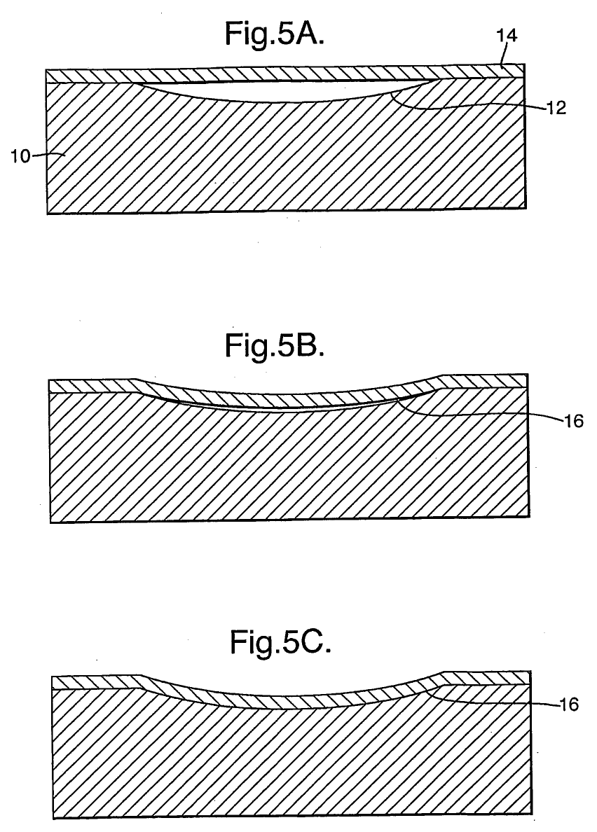

Referring to FIG. 5, this shows in a schematic way, an electrostatic actuator working on the zip principle and comprising a fixed electrode 10 with a smooth and gentle contoured surface 12, formed as described above with reference to FIG. 1. A flexible electrode 14 is secured to the top surface of fixed electrode 10 over surface 12. As shown in FIG. 5A, flexible moving electrode 14 in operation firstly pulls in from its outer edges onto curved surface 12 of fixed electrode 10. In FIG. 5B, a ‘vanishing’ gap 16 around periphery of flexible moving electrode maintains maximum available force, as the edge regions of electrode 14 come into contact with surface 12. In FIG. 5C, the gap 16 zips in towards centre of surface 12. The resulting effect is to allow moving electrode 14 to be deflected with large displacements.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of forming a surface of micrometer dimensions conforming to a desired contour, the method comprising providing a substrate with a recess in a surface thereof, providing a layer of a predetermined material over the surface of the substrate to cover the recess, bonding at least edge regions of said layer to the substrate, and applying heat to said layer and applying pressure on said layer, such as to plastically deform said layer within the recess to a desired contour.

2. A method according to claim 1, wherein said layer is plastically deformed such as to abut against the surface of the recess, which is effective to inhibit further plastic deformation.

3. A method according to claim 1, wherein the space between the recess and said layer is evacuated to create a vacuum pressure, so that subsequent application of heat enables plastic deformation and a drawing in of said layer within the recess.

4. A method according to claim 3, wherein said layer is fusion bonded to the substrate surface.

5. A method according to claim 3, wherein said plastic deformation takes place at an external atmospheric pressure.

6. A method according to claim 1, wherein the desired contour is dish-shaped, having a width or diameter between 1 mm and 50 mm and a depth between 50 and 1000 micrometers.

7. A method according to claim 1, wherein the material of the layer is crystalline silicon.

8. A method according to claim 7, wherein the substrate comprises a layer of crystalline silicon and the diaphragm comprises a further, thinner, layer of crystalline silicon.

9. A method according to claim 1, wherein the material of the layer is glass.

10. A method according to claim 1, including forming at least one venting aperture in the plastically deformed layer.

11. A method according to claim 1, wherein said recess is formed by grey scale etching.

12. A MEMS device including a substrate having a recess in a surface thereof, and a single layer of a predetermined material bonded to the substrate and plastically deformed within the recess so as to constitute the surface of the recess, the surface of the recess conforming to a desired contour.

13. A device according to claim 12, wherein said predetermined material is one of crystalline silicon and glass.

14. A device as claimed in claim 12, wherein the surface of the recess is dish-shaped, having a width or diameter between 1 mm and 50 mm and a depth between 50 and 1000 micrometers.

15. A device according to claim 11, including one or more venting apertures formed in the surface of the recess.
